(19) United States
(12) Patent Application Publication
(10) Pub. No.: US 2018/0023549 A1
(43) Pub. Date: Jan. 25, 2018

(54) Gravity-Lever-Actuated Rotating Engine

(71) Applicant: Eugene Smith, Tyler, TX (US)

(72) Inventor: Eugene Smith, Tyler, TX (US)

(21) Appl. No.: 15/654,320

(22) Filed: Jul. 19, 2017

Related U.S. Application Data
(60) Provisional application No. 62/363,897, filed on Jul. 19, 2016.

(51) Int. Cl. F03G 3/00; H02K 7/18

(52) U.S. Cl. CPC F03G 3/00; H02K 7/1807; F03G 7/10

(57) ABSTRACT

A gravity-lever-actuated rotating engine which emulates a perpetual motion machine by appearing to produce more energy than is required to power the engine. The gravity-lever-actuated rotating engine produces energy by utilizing a combination of forces, such as gravity, centrifugal force, and air pressure, causing a lever arm featuring shifting weights to rotate about an axis. Accordingly, the gravity-lever-actuated rotating engine appears to produce more energy than is required to power the engine due to the utilization of a combination of “natural” forces, such as gravity and centrifugal force.

### CROSS-REFERENCE TO RELATED APPLICATIONS

This application claims the benefit of U.S. Provisional Patent Application No. 62/363,897 filed Jul. 19, 2016, by the present inventor.

### TECHNICAL FIELD

The present apparatus relates generally to engines; and, more particularly, to gravity-powered engines.

### BACKGROUND

The following is a tabulation of some prior art that presently appears relevant:

U.S. Patents

| Patent Number | Issue Date | Patentee |
|---|---|---|
| U.S. Pat. No. 4,751,486 | Jun. 14, 1988 | Minato |

U.S. patent application Publications

| Publication Number | Publication Date | Applicant |
|---|---|---|
| U.S. 2007/0246939 A1 | Oct. 25, 2007 | McDonald |
| U.S. 2008/0164772 A1 | Jul. 10, 2008 | Molette |
| U.S. 2007/0257489 A1 | Nov. 8, 2007 | Wang |

The concept of a perpetual motion machine has long piqued imaginations throughout history as physicists have tried to push the boundaries of physics. Hypothetically, a perpetual motion machine could produce an infinite stream of energy as the kinetic energy released from such a machine would be magnitudes greater than the potential energy required to start the machine into motion. However, due to the laws of thermodynamics, such perpetual motion machines remain hypothetical because the energy required to drive the motion of such a machine is eventually exhausted.

Nevertheless, scientist have long tried to perfect “apparent” perpetual motion machines in attempts to stretch the laws of physics. Some of the most well-known attempts have include float belts—which utilize the buoyancy force of water—to capillary bowls—which utilize the change in water pressure between the inside and outside of a capillary tube at a certain depth. More recent examples include variations of an overbalanced wheel, which utilizes shifts in the center of gravity to keep the wheel spinning. However, all such apparent perpetual motion machines have fallen short of providing any actual utility, as they all relatively quickly reach a state of equilibrium.

Regardless of the limitations of previous iterations of perpetual motion machines, physicists and engineers continue to work towards reaching a maximum level of machine and/or motor efficiency as the need for energy throughout the world continues to increase. To date, there exists no known motor or machine which properly emulates a perpetual motion machine, maximizing the efficiency of the motor or machine, thereby producing the greatest amount of energy out of the motor or machine.

### SUMMARY OF THE INVENTION

In accordance with the invention, a machine which properly emulates an apparent perpetual motion machine can be accomplished through a machine which utilizes multiple forms of energy in to produce one form of energy out—the result of which appears to be a machine that produces more energy than it uses.

In a particular embodiment of the invention, an emulated perpetual motion machine can be accomplished through gravity acting as torque on a moment arm while centrifugal force and air pressure are utilized to shift the center of gravity of said moment arm. In accordance with a particular embodiment of the invention, the emulated perpetual motion machine may feature a rotating lever arm with shifting weights attached on opposite sides of the axis of rotation of the lever arm. As the lever arm turns, the weights on the lever arm may shift, thereby shifting the center of gravity of the lever arm to keep the lever arm turning with ease. Additionally, the shifting of the weights may be controlled to keep the shift in the center of gravity constant through each rotation of the lever arm.

Accordingly, in a particular embodiment of the invention, the only “unnatural” source of energy used to power the machine would be the relatively small amount of energy required to re-position the weights. The other sources of energy into the system include the “natural” sources of gravity and centrifugal force. However, the machine also produces energy due to the rotation of the lever arm. Theoretically, the energy produced by the machine is only greater than the “unnatural” energy used by the machine. However, since energy is created through the rotation of the lever arm, the result appears to be a machine which produces more energy than it uses—an emulated perpetual motion machine.

### BRIEF DESCRIPTION OF THE DRAWINGS

FIG. 1 is an isometric view of a gravity-lever-actuated rotating engine embodying the principles of the present invention;

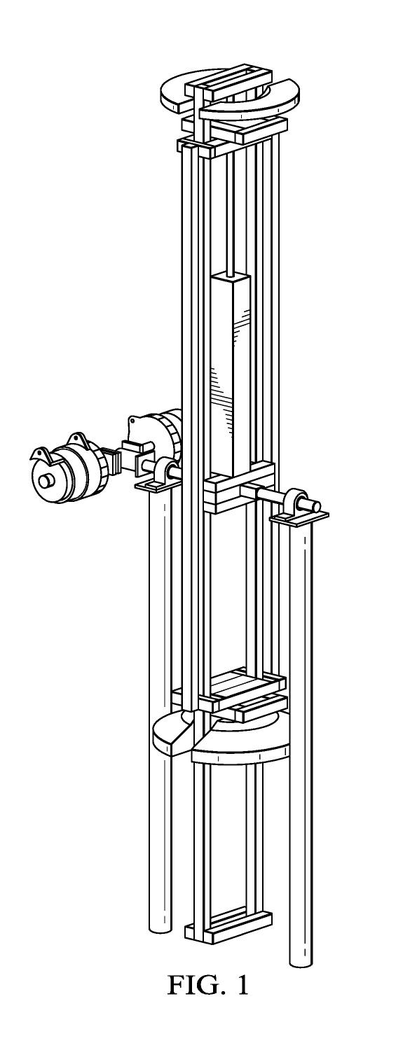

FIG. 2 is a side view of a gravity-lever-actuated rotating engine embodying the principles of the present invention;

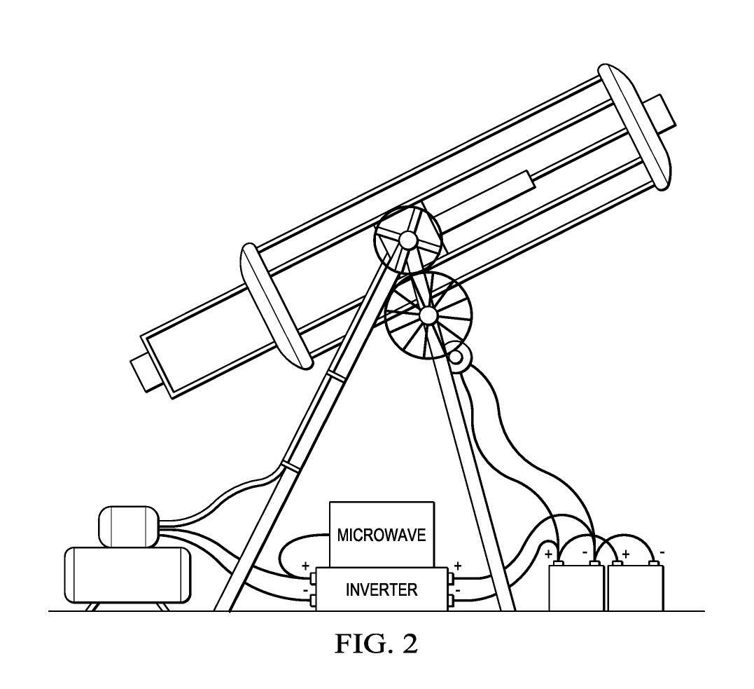

FIG. 3 is a side view of a gravity-lever-actuated rotating engine embodying the principles of the present invention;

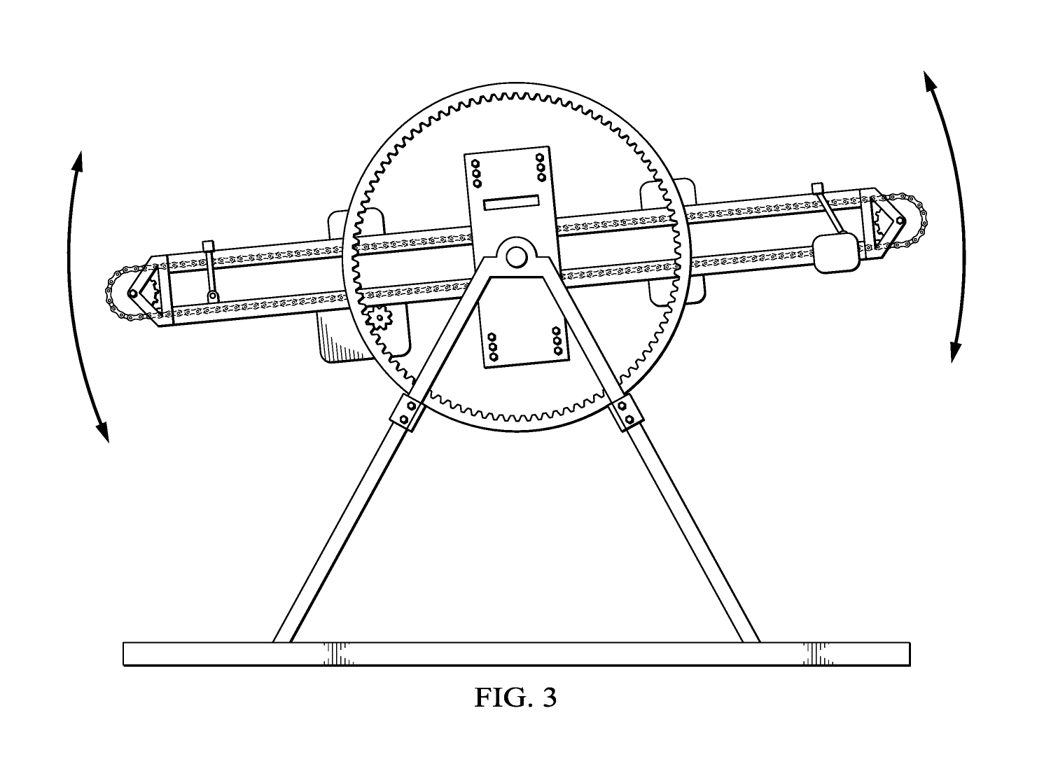

FIG. 4 is a side view of a gravity-lever-actuated rotating engine embodying the principles of the present invention;

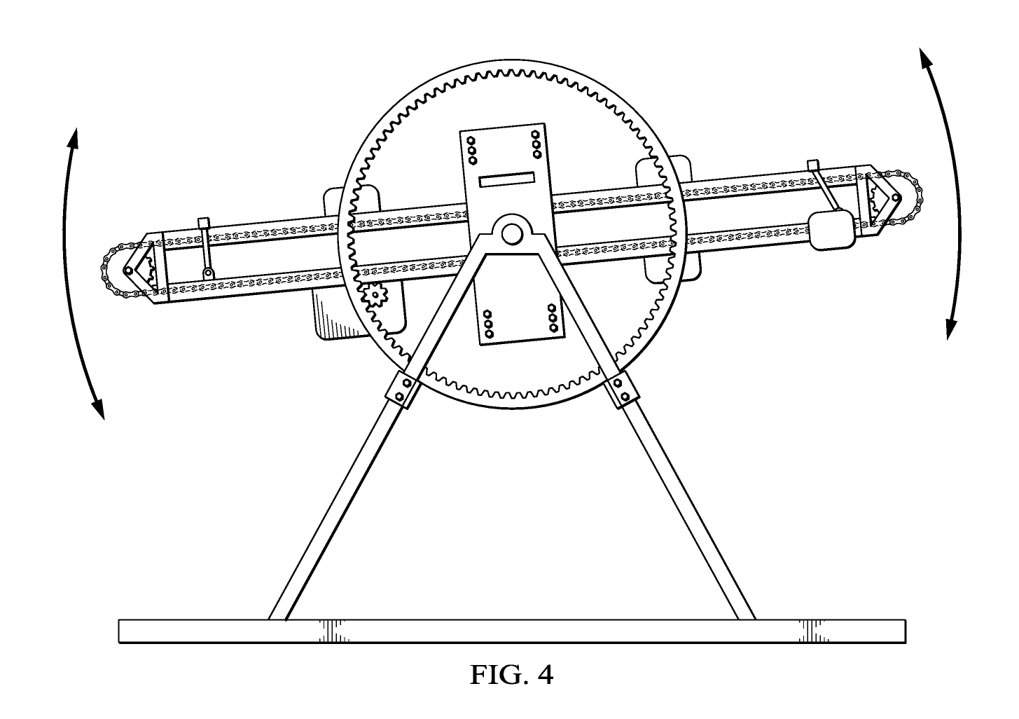

FIG. 5 is an isometric view of mounting plates and a center shaft on a gravity-lever-actuated rotating engine embodying the principles of the present invention;

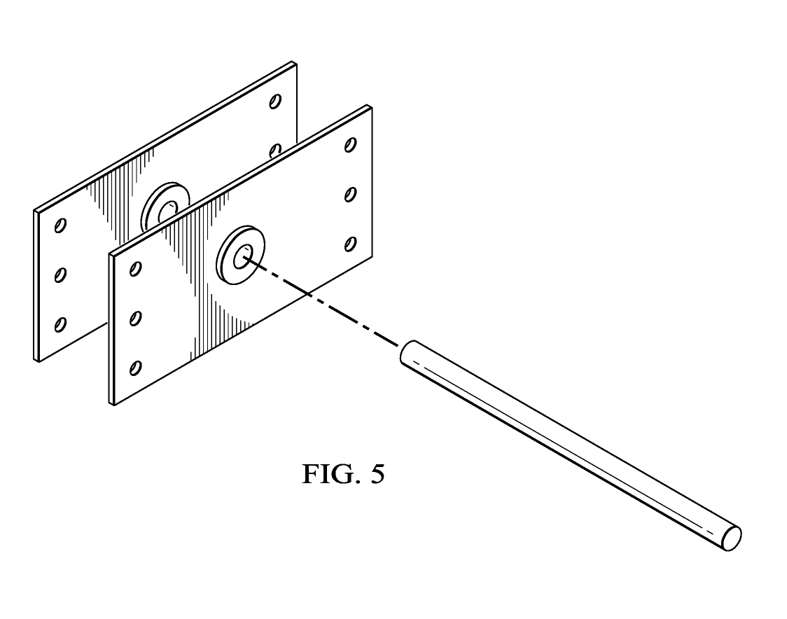

FIG. 6 is a side view of a lever arm on a gravity-lever-actuated rotating engine embodying the principles of the present invention;

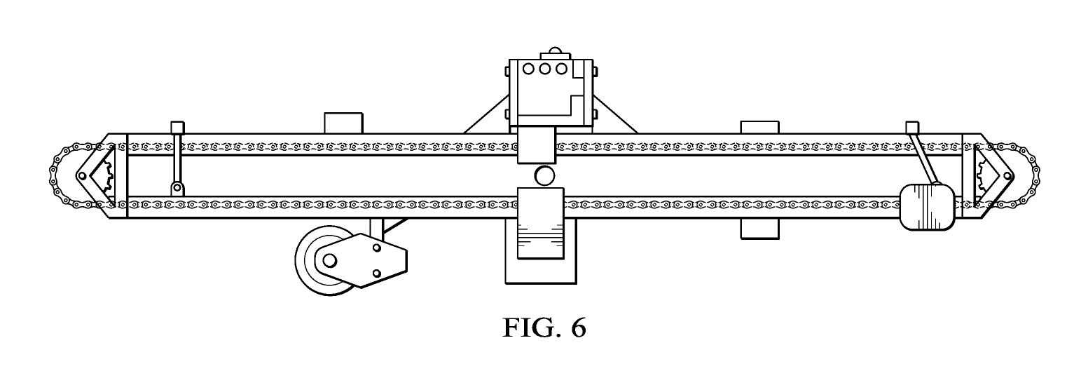

FIG. 7 is an isometric, exploded component view of sprocket end mounts on a gravity-lever-actuated rotating engine embodying the principles of the present invention;

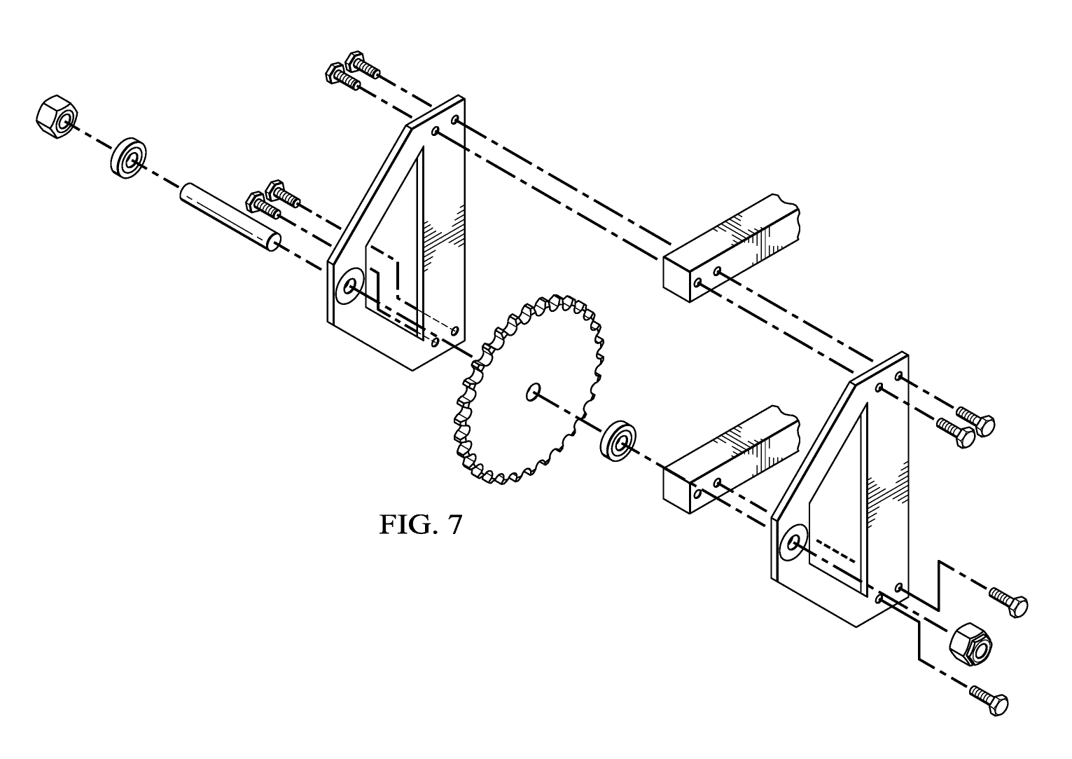

FIG. 8 is a front view of a sprocket end mount on a gravity-lever-actuated rotating engine embodying the principles of the present invention;

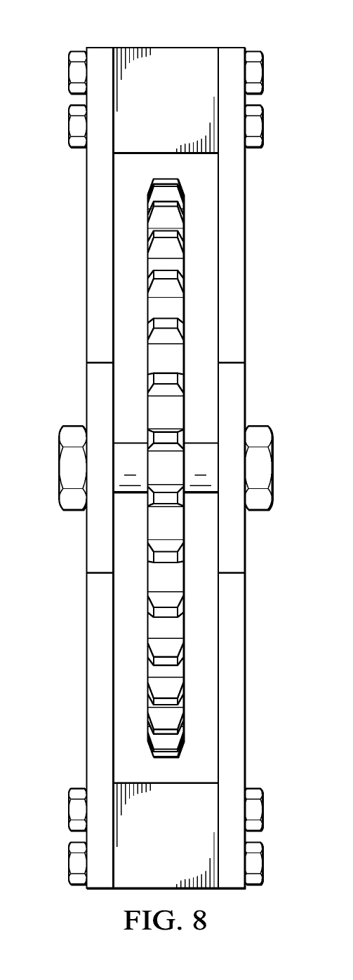

FIG. 9 is an isometric, component view of a lever arm structure on a gravity-lever-actuated rotating engine embodying the principles of the present invention;

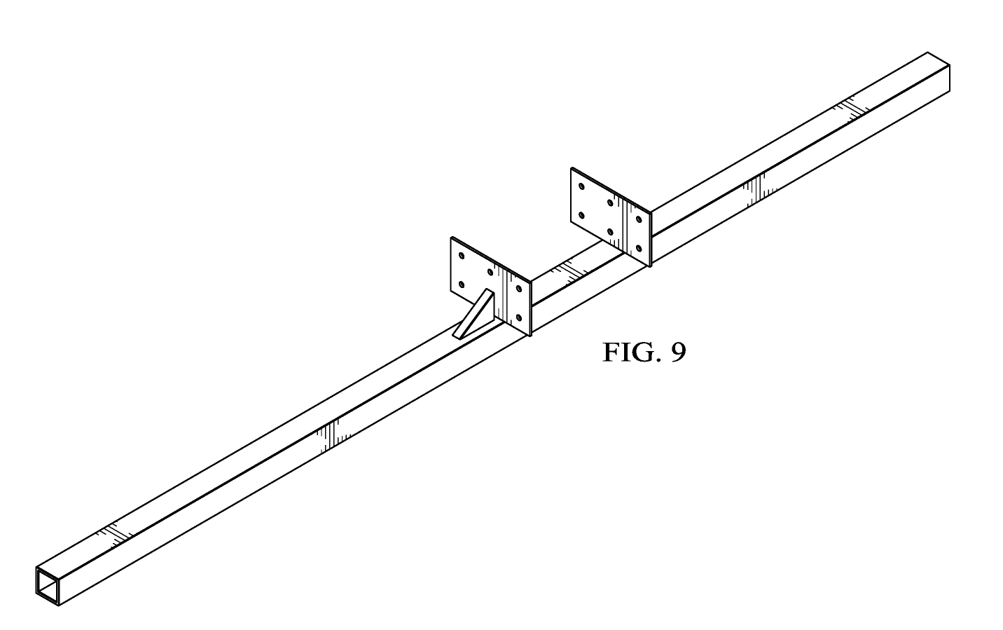

FIG. 10 is a front, component view of a mounting bracket on a gravity-lever-actuated rotating engine embodying the principles of the present invention;

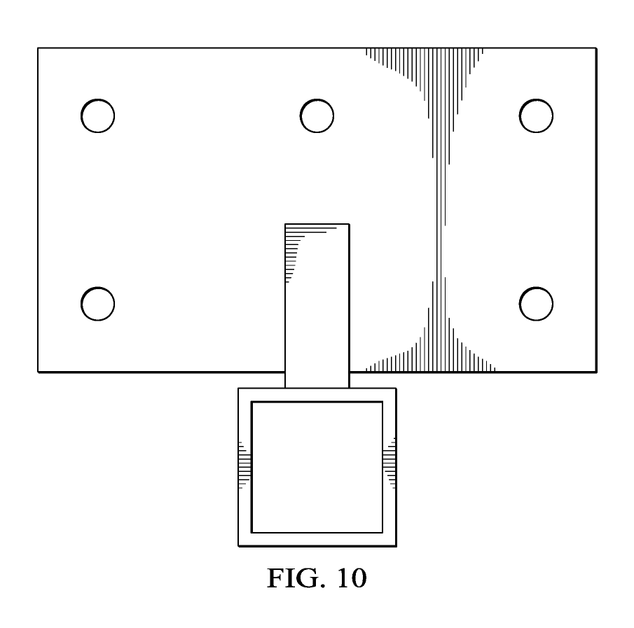

FIG. 11 is an isometric, component view of a mounting bracket on a gravity-lever-actuated rotating engine embodying the principles of the present invention; and

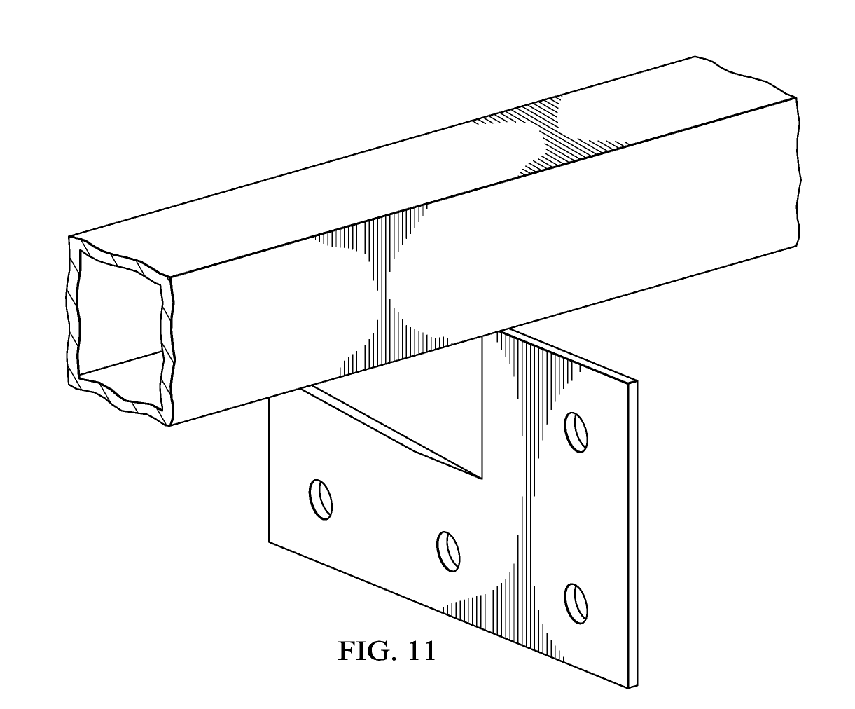

FIG. 12 is an isometric, component view of a sliding weight on a gravity-lever-actuated rotating engine embodying the principles of the present invention.

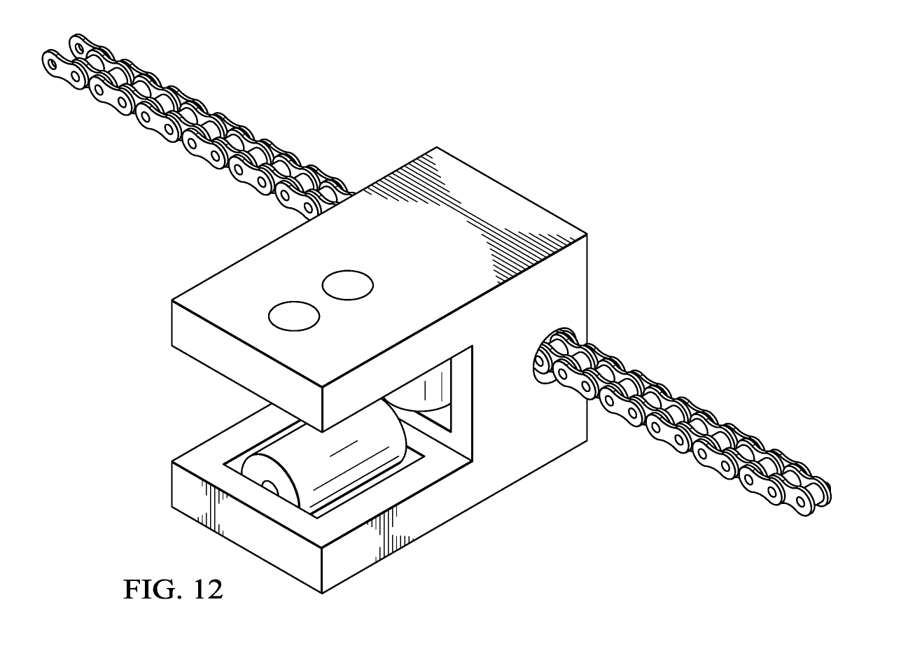

### DETAILED DESCRIPTION OF THE INVENTION

As noted above, the concept of a perpetual-motion machine is a highly-desired concept as leading physicists and engineers continue the pursuit of a way to harness clean and renewable energy. However, the laws of thermodynamics have prevented the usefulness for previous attempts to create such a perpetual-motion machine. Currently, no known apparatus exists which seems to break the laws of thermodynamics and produce motion—and, thus, energy—perpetually.

The present invention is an inertia-creating, gravity-lever-actuated, rotating, recycling engine (hereinafter, “IC-GLARRE”). Similar to a water wheel, the IC-GLARRE apparatus uses the natural force of gravity as the means of overcoming the moment of inertia on the apparatus to produce rotational motion which is converted to energy out of the system.

The present invention is generally comprised of a tower structure, a rotating lever arm on the tower structure, a permanent magnet generator, and shifting weights. The weights are positioned on a sliding track that is part of the rotating lever arm. At the start of operation, the rotating lever arm is positioned in a vertical position along the tower structure with the rotational axis of the rotating lever arm connected to the tower structure. The sliding weights are positioned with one weight on each side of the rotational axis (i.e., each arm of the rotating lever arm relative to the pivot point).

In a particular embodiment of the present invention, an air compressor, powered by a relatively small horsepower motor, shifts the weights along the sliding track to where the weight in the highest position is shifted to the end of the rotating lever arm and the weight in the lowest position is shifted towards the pivot point of the rotating lever arm. This shift in weight lengthens the moment arm on the highest segment of the rotating lever arm while simultaneously shortening the moment arm on the lowest segment of the rotating lever arm, thereby allowing gravity to rotate the lever arm by overcoming the moment of inertia for the rotating lever arm. Once the lever arm performs a half revolution, the weights are then re-shifted by the air compressor to where the weight in the highest position is shifted to the end of the rotating lever arm and the weight in the lowest position is shifted back towards the pivot point of the rotating lever arm. The rotation of the lever arm powers a series of pulleys connected to a permanent magnet generator, thereby creating energy.

In another embodiment of the present invention, the weights may be attached and moved along a drive chain to adjust the moment arm of the rotating lever arm. In accordance with a particular embodiment of the present invention, a relatively small motor may rotate a chain extending around the perimeter of the rotating lever arm at each rotation when the lever arm is perpendicular to the ground. In such an embodiment, the chain may be further connected to the weights positioned along a sliding track in order to shift weights to the end of the lever arm when the lever arm is perpendicular to the ground, thereby increasing the moment arm and force output when the lever arm rotates. In such an embodiment, once the lever arm performs another half revolution, a gravity switch located on a mounting plate may be activated and reverse the flow of electricity from the generator and back into the motor to then re-shift weights to the end of the lever arm to, again, increase the moment arm. In such an embodiment, a generator and gear box may be mounted onto the rotating lever arm, wherein the gear box may feature any desired step-up gear ratio and be interconnected to a fixed ring gear mounted to the frame of the apparatus.

Although friction cannot be avoided, the IC-GLARRE apparatus utilizes a series of ball bearings in the pivot point of the rotating lever arm to minimize the friction throughout the system. This minimizing of friction allows the IC-GLARRE apparatus to rotate and create energy relatively free of any artificial power source, when, for example, an air compressor or drive chain—powered by a relatively small motor—is only used to shift the position of the weights at every half revolution. Accordingly, the IC-GLARRE apparatus utilizes gravity at the primary source of “energy-in” to create “energy-out” that is greater than the amount of artificial energy required to power the air compressor. Moreover, the IC-GLARRE can also occasionally use the energy “surplus” to revive the loop of the IC-GLARRE apparatus, thereby drastically increasing the potential number of revolutions of the IC-GLARRE rotating lever arm—which could theoretically be extended to perpetuity.

The foregoing merely illustrates the principles of the present invention. Therefore, it will be appreciated that those skilled in the art will be able to devise numerous alternative arrangements that, while not shown or described herein, embody the principles of the invention and thus are within the spirit and scope of the invention.

What is claimed is:

1. A gravity-lever-actuated rotating apparatus configured to emulate perpetual motion, comprising:
at least one elongated base structure;
at least one lever arm configured to rotate about a fixed axis;
an electric generator; and
at least one electric power source.

2. The gravity-lever-actuated rotating apparatus of claim 1, wherein said fixed axis of said lever arm is located at the lever arm's center of mass.

3. The gravity-lever-actuated rotating apparatus of claim 2, wherein said fixed axis of said lever arm is connected to an axle on said elongated base structure.

4. The gravity-lever-actuated rotating apparatus of claim 3, wherein said lever arm is further comprised of one or more sliding tracks, one or more air compressors, and weights.

5. The gravity-lever-actuated rotating apparatus of claim 4, wherein said sliding tracks extend along a radius on each side of said fixed axis of said lever arm.

6. The gravity-lever-actuated rotating apparatus of claim 5, wherein an equal amount of said weights are connected to said sliding tracks on both sides of the fixed axis of said lever arm.

7. The gravity-lever-actuated rotating apparatus of claim 6, wherein said weights are configured to slide on said sliding tracks along the total length of the radius on each side of said fixed axis of said lever arm.

8. The gravity-lever-actuated rotating apparatus of claim 7, wherein said air compressor is configured to move said weights along said sliding tracks.

9. The gravity-lever-actuated rotating apparatus of claim 8, wherein the weights on a top half of said lever arm are configured to move to the distal end of said top half of said lever arm when the lever arm is oriented vertically.

10. The gravity-lever-actuated rotating apparatus of claim 9, wherein the weights on a bottom half of said lever arm are configured to move to the proximal end of said bottom half of said lever arm when the lever arm is oriented vertically.

11. The gravity-lever-actuated rotating apparatus of claim 10, wherein said electric generator is selected from the group consisting of: a permanent magnet generator, a permanent magnet alternator, a magneto, and a dynamo.

12. The gravity-lever-actuated rotating apparatus of claim 3, wherein said elongated base structure is further comprised of a fixed ring gear mounted to said elongated base structure and centered around said fixed axis.

13. The gravity-lever-actuated rotating apparatus of claim 12, wherein said lever arm is further comprised of one or more sliding tracks, one or more drive chains, and weights.

14. The gravity-lever-actuated rotating apparatus of claim 13, wherein said lever arm is connected to mounting plates configured to rotate about a shaft connected to said elongated base structure.

15. The gravity-lever-actuated rotating apparatus of claim 14, wherein said mounting plates are further comprised of a gravity switch connected to a mounting plate.

16. The gravity-lever-actuated rotating apparatus of claim 15, wherein said drive chains are configured to move said weights along said sliding tracks.

17. The gravity-lever-actuated rotating apparatus of claim 16, wherein the weights on a top half of said lever arm are configured to move to the distal end of said top half of said lever arm when the lever arm is oriented vertically.

18. The gravity-lever-actuated rotating apparatus of claim 17, wherein the weights on a bottom half of said lever arm are configured to move to the proximal end of said bottom half of said lever arm when the lever arm is oriented vertically.

19. The gravity-lever-actuated rotating apparatus of claim 18, wherein said electric generator is selected from the group consisting of: a permanent magnet generator, a permanent magnet alternator, a magneto, and a dynamo.
